(19) United States
(12) Patent Application Publication
(10) Pub. No.: US 2006/0232858 A1
(43) Pub. Date: Oct. 19, 2006

(54) Angular attachment for the eyepiece of a rangefinder camera

(75) Inventors: Peter Karbe, Leun (DE); Holger Wiegand, Giessen (DE)

Correspondence Address: FOLEY AND LARDNER LLP;SUITE 500, 3000 K STREET NW, WASHINGTON, DC, 20007, US

(73) Assignee: LEICA CAMERA AG

(21) Appl. No.: 11/404,751

(22) Filed: Apr. 17, 2006

(30) Foreign Application Priority Data
Apr. 18, 2005 (DE) 10 2005 018 010.8

(51) Int. Cl. G02B 23/00

(52) U.S. Cl. 359/431; 359/831

(57) ABSTRACT

An angular attachment has a housing (1) for fixing to an eyepiece (15) of a rangefinder camera (21) with laterally correct and height-correct representation of the finder image at an altered eyepiece angle, which contains a Bauernfeind prism (5) with double reflection in one plane as an image deflection element, a first region (A, A′) of a base area (4) of the Bauernfeind prism (5) is disposed downstream of the eyepiece finder (15), an area opposite to this region is formed as a reflective area (8) and is inclined with respect to the base area (4) in such a way that a ray (2) entering the first region perpendicularly is reflected onto a second region (B, B′) of the base area (4) at an angle of total reflection, and a light exit area (10) of the Bauernfeind prism (5) is inclined relative to the base area (4) in such a way that the totally reflected ray (9) impinges perpendicularly on the light exit area (10).

### CROSS-REFERENCE TO RELATED PATENT APPLICATIONS

The right of foreign priority is claimed under 35 U.S.C. § 119(a) based on Federal Republic of Germany Application No. 10 2005 018 010.8, filed Apr. 18, 2005, the entire contents of which, including the specification, drawings, claims and abstract, are incorporated herein by reference.

### BACKGROUND OF THE INVENTION

The invention relates to an angular attachment having a housing for fixing to the eyepiece of a rangefinder camera with laterally correct and height-correct representation of the finder image at an altered eyepiece angle.

Angular attachments of this type are also referred to as angular finders and are known per se.

In the case of photographic cameras, normally the eye looking through the viewfinder and the photographer face the photographed object. In other cases, for example in the case of macrophotographs of plants or animals near the ground, or in the case of portrait photographs of seated persons, this normal eyepiece direction is disadvantageous.

Medium-format reflex cameras are popular, therefore, in the field of portrait photography. In the case of these cameras, the photographer can observe the photographed subject, which is projected through an objective from a mirror at right angles upwardly onto a ground glass screen, in a so-called light shaft at an angle of 90° with respect to the photographed object. Although the viewed image is upright as a result of the single mirror-reflection, it is laterally reversed, which makes image composition more difficult.

DE 29 52 207 A1 discloses an angular finder which can be separated from the mirror casing. The angular finder designated as a prismatic finder enables an altered eyepiece angle of approximately 45° with respect to the optical axis of the objective. It has a pentaprism with a roof edge for the laterally correct representation of the finder image and double reflection in one plane for the height-correct representation.

Taking photographs with rangefinder cameras differs considerably from this, however. The image composition and focusing are not effected on the basis of a viewed image which has been generated in a laterally reversed and height-reversed manner through the photographic objective. The finder image of a rangefinder camera is generated in a laterally correct and height-correct manner at the eyepiece by means of a separate optical system. The eye looking through the finder faces the photographed object and the focusing is effected on the basis of a mixed image.

DE C 657 348 discloses an interchangeable angular finder which enables a straight and also an altered eyepiece angle, namely perpendicular to the photographing direction. The interchangeable angular attachment is of complicated construction and contains two lenses and a pentaprism.

DE 199 58 332 A1 discloses a complicated optical system for a real image finder in which provision is made of a Bauernfeind prism with double reflection of the imaging rays in one plane. The prism has an objective disposed upstream of it and a further prism disposed downstream of it. The system requires a large installation space and the prism does not have a compact constructional form.

If interchangeable photographic objectives having different focal lengths are provided in the case of rangefinder cameras, the rangefinder system contains different masks as bright-line frames which are assigned to the image field of the respective focal length and are reflected into the rangefinder ray path. The calculated or set exposure time is represented in a region outside the bright-line frames. The photographer can register the entire finder image field only if his eye is situated directly and without any distance at the eyepiece of the rangefinder camera.

An angular finder of simple configuration is known from DE-C 678 276 and comprises a mirror fitted obliquely at a distance from the eyepiece of the finder. The housing for accommodating the mirror can be rotated about the finder axis and thus enables different eyepiece directions lying transversely with respect to said axis. As a result of the simple mirror-reflection, however, the finder image is represented in a height-reversed manner in the case of an eyepiece from above and in a laterally reversed manner in the case of an eyepiece from the side. The mirror fitted at a large distance from the eyepiece of the finder does not enable an overview of the entire finder image field. Exterior indication elements and mask frames are no longer visible.

### SUMMARY OF THE INVENTION

Therefore, the invention was based on an object of improving the angular attachment in such a way that it enables an overview of a largest possible region of the finder in a laterally correct and height-correct representation, is constructed simply and compactly and at the same time can be rotated about the finder axis in any desired direction.

In the case of an angular attachment of the type mentioned in the introduction, this object is achieved by means of the features described below.

In the case of the angular attachment according to one embodiment of the invention, a Bauernfeind prism with double reflection in one plane is provided as an image reversal element. The optical path through the angular attachment is kept very short in this way and a laterally correct and height-correct representation of the finder image appears at the light exit area. A first region of the base area of the Bauernfeind prism is disposed downstream of the eyepiece of the rangefinder camera and the area opposite to said region is formed as a reflective area. The reflective area is inclined in such a way that a ray entering the first region perpendicularly is reflected onto a second region of the base area at an angle of total reflection. In this way, the base area can advantageously be utilized simultaneously for the ray passage and the total reflection without complicated maskings and different optical coatings being required on said area. Total reflection occurs at any transition from an optically denser to an optically less dense medium if the so-called critical angle is exceeded. The latter is produced according to the law of refraction from the arc-sine of the ratio of the refractive index of the optically less dense medium to that of the optically denser medium. In the case of the Bauernfeind prism according to embodiments of the invention, the light exit area is inclined relative to the base area in such a way that the totally reflected ray impinges perpendicularly on the light exit area and undesirable refraction effects are avoided in this way. The image deflection angle is independent of the prism rotation.

In an advantageous refinement of the invention for a comfortable eyepiece view into the angular attachment, the reflective area forms an angle of 24° and the light exit area forms an angle of 48° with the base area. This results in a particularly compact embodiment of the prism with a small glass volume. In this case, the eyepiece view into the angular attachment is effected at 48° with respect to the optical axis of the eyepiece finder of the rangefinder camera, which has proved to be particularly universal and comfortable for the user. It goes without saying that other eyepiece angles are also possible and can be varied by means of a suitable choice of the refractive index of the glass of the prism, in the range of the condition for total reflection. If the light ray, for complying with the conditions for total reflection, is intended to impinge on the base area for example at a minimum angle of approximately 39°, n=1.589 results for the minimum refractive index of the glass to be used for the prism.

In order to protect the interface of the glass/air transition at the base area against contamination, in a further refinement, a plane glass sheet with an air clearance is arranged before the base area. By virtue of ensuring this absolutely clean interface, there is the possibility that edge regions of the incident beam of rays can overlap edge regions of the reflected beam of rays that has undergone total reflection on the base area without disturbing arising optical superposition effects.

In a further embodiment, a frame-type adhesive film is provided as a spacer between the plane glass sheet and the base area of the prism. In this way, it is possible simultaneously to fix the plane glass to the prism in a simple manner and to seal the interspace in an airtight manner. The base area of the prism is thus permanently and reliably protected against contamination during use. A disturbance of the total reflection is thereby prevented.

In an advantageous manner, in the case of an angular attachment according to an embodiment of the invention, the housing has an eyepiece mount on the light exit side, said eyepiece mount being closed off with a plane glass sheet toward the interior of the housing and being provided with a rubber reinforcement on the eyepiece side. This measure effectively prevents the light exit area of the deflection prism from being picked up and thereby contaminated. The eye can be placed at the rubber reinforcement in a comfortable manner.

For persons wearing spectacles, there is the disadvantage that, as a result of the spectacles, their eye is already at a considerable distance behind the eyepiece and a complete overview of the finder region cannot be provided. In one variation of the invention, therefore, the eyepiece mount of the angular attachment has on the eyepiece side an internal thread for receiving a dioptre compensation lens. In this way, it is possible for persons wearing spectacles to register a sharp and as complete a finder image as possible without spectacles.

In a particularly advantageous refinement, on the light entry side, provision is made of a fixing screw mounted rotatably in the housing and having an external thread for screwing into the eyepiece finder of the camera. In this way, the housing is to be rotated in a fixable manner about the optical axis of the eyepiece finder of the camera and thus enables different eyepiece directions lying transversely with respect to said axis, the image representation being maintained.

A fixing screw having a knurled ring projecting from the housing is particularly advantageous. The screw connection is released in a particularly simple manner and the housing can conveniently be rotated into the position desired by the photographer and subsequently be screwed tight again.

In a further refinement, the internal thread on the eyepiece mount and the external thread for screwing into the eyepiece finder are of the same type, preferably M12×0.5 mm. In this way, a high degree of compatibility with other supplementary parts is ensured and accessories that are provided for the eyepiece finder of the camera can likewise be used on the new housing.

Further objects, features and advantages of the present invention will become apparent from the detailed description of preferred embodiments that follows, when considered together with the accompanying figures.

### BRIEF DESCRIPTION OF THE DRAWINGS

Exemplary embodiments of an angular attachment according to the invention are illustrated schematically in the drawings and are described in more detail below with reference to the figures, in which:

FIG. 1 shows a sectional illustration through an angular attachment,

FIG. 2 shows the arrangement of the angular attachment on a rangefinder camera in a vertical representation, and

FIG. 3 shows the same arrangement in a horizontal orientation of the angular attachment.

### DETAILED DESCRIPTION OF THE PREFERRED EMBODIMENTS

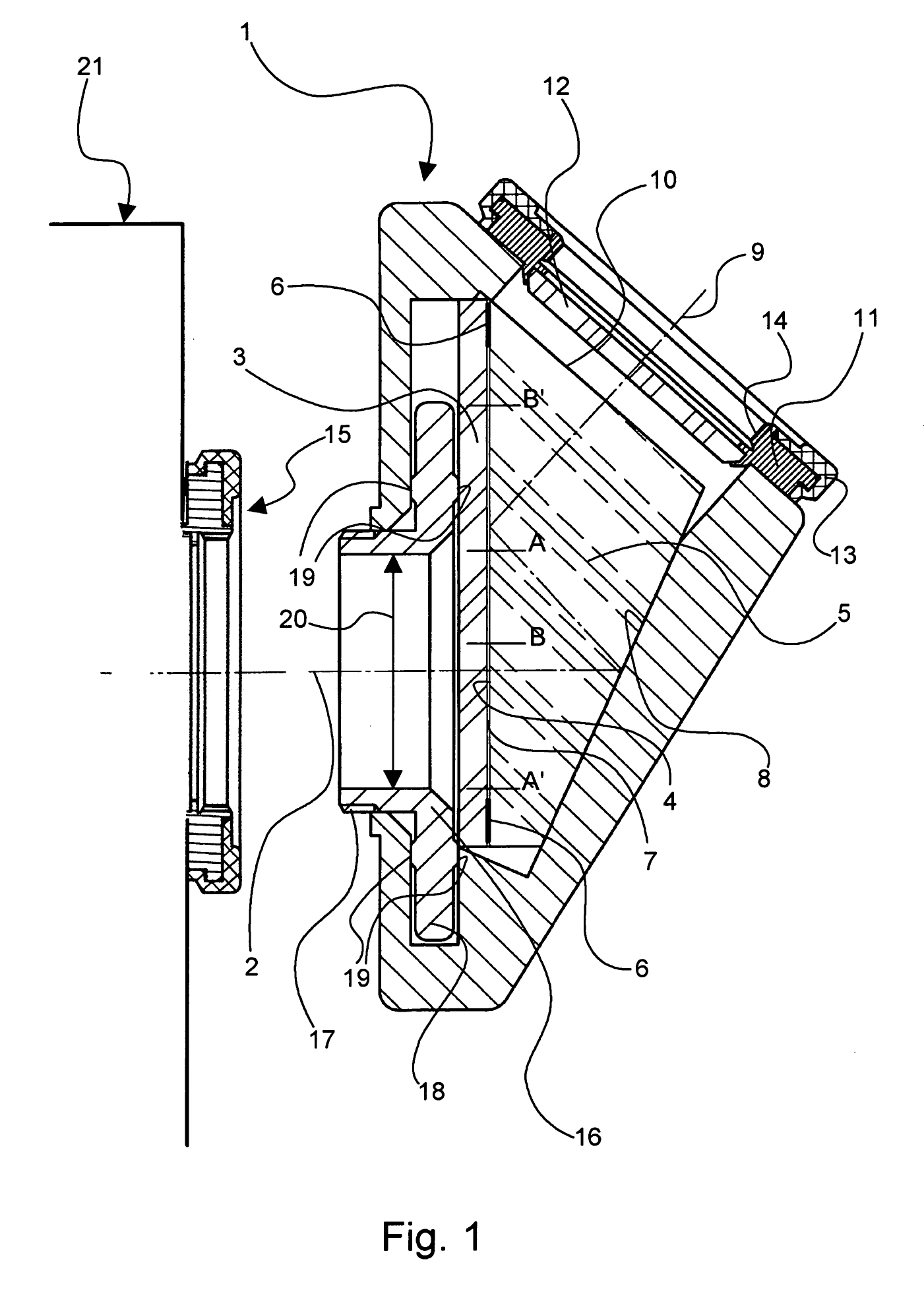

FIG. 1 shows a longitudinal sectional illustration of an angular attachment 1 according to the invention with its details. A ray 2 entering into the housing 1 impinges perpendicularly on a plane glass sheet 3 and, after passing through the latter, enters perpendicularly again into a first region of a base area 4 of a Bauernfeind prism 5. The plane glass sheet 3 is fixed to the Bauernfeind prism 5 by means of an adhesive film 6 and produces an air clearance 7 in this way. The ray 2 that has entered into the Bauernfeind prism 5 impinges on a reflective area 8, is reflected at an angle of total reflection onto a second region of the base area 4 and exits perpendicularly from the light exit area 10 as a totally reflected ray 9 at an angle of 48° with respect to the incident ray 2.

The termination of the housing 1 on the light exit side is formed by an eyepiece plane glass sheet 12 mounted in an eyepiece mount 11. The eyepiece mount 11 is provided with a rubber reinforcement 13 for the eye to rest comfortably and has an internal thread 14 for receiving dioptre compensation lenses (not illustrated).

The housing 1 is fixed to an eyepiece finder 15 of a camera by means of a fixing screw 16 with an external thread 17. The fixing screw 16 can be conveniently rotated by means of a knurled ring 18 projecting from the housing 1. The knurled ring 18 has sliding knobs 19 which are distributed regularly on its exterior areas in the radial direction, support the position of the fixing screw 16 in the housing 1 and enable low-noise rotation. In order to improve the slideability of the sliding knobs 19, films (such as polytetrafluoroethylene films such as TEFLON films) may be applied to the housing 1 and on the plane glass sheet 3.

The finder ray beam corresponding to the incident ray 2 is not illustrated any further, but is influenced geometrically by the entrance diameter 20 of the fixing screw 16. In order to illustrate the first region of the base area 4 of the Bauernfeind prism 5, said first region being mentioned in connection with the incident ray 2, reference symbols A, A′ are inserted, which are intended to demarcate the first region through which the finder ray beam passes. The second region of total reflection of the ray beam is likewise indicated by B, B′. This illustration schematically shows the overlap A/B between the first region A, A′ and the second region B, B′ on the base area 4 of the Bauernfeind prism 5.

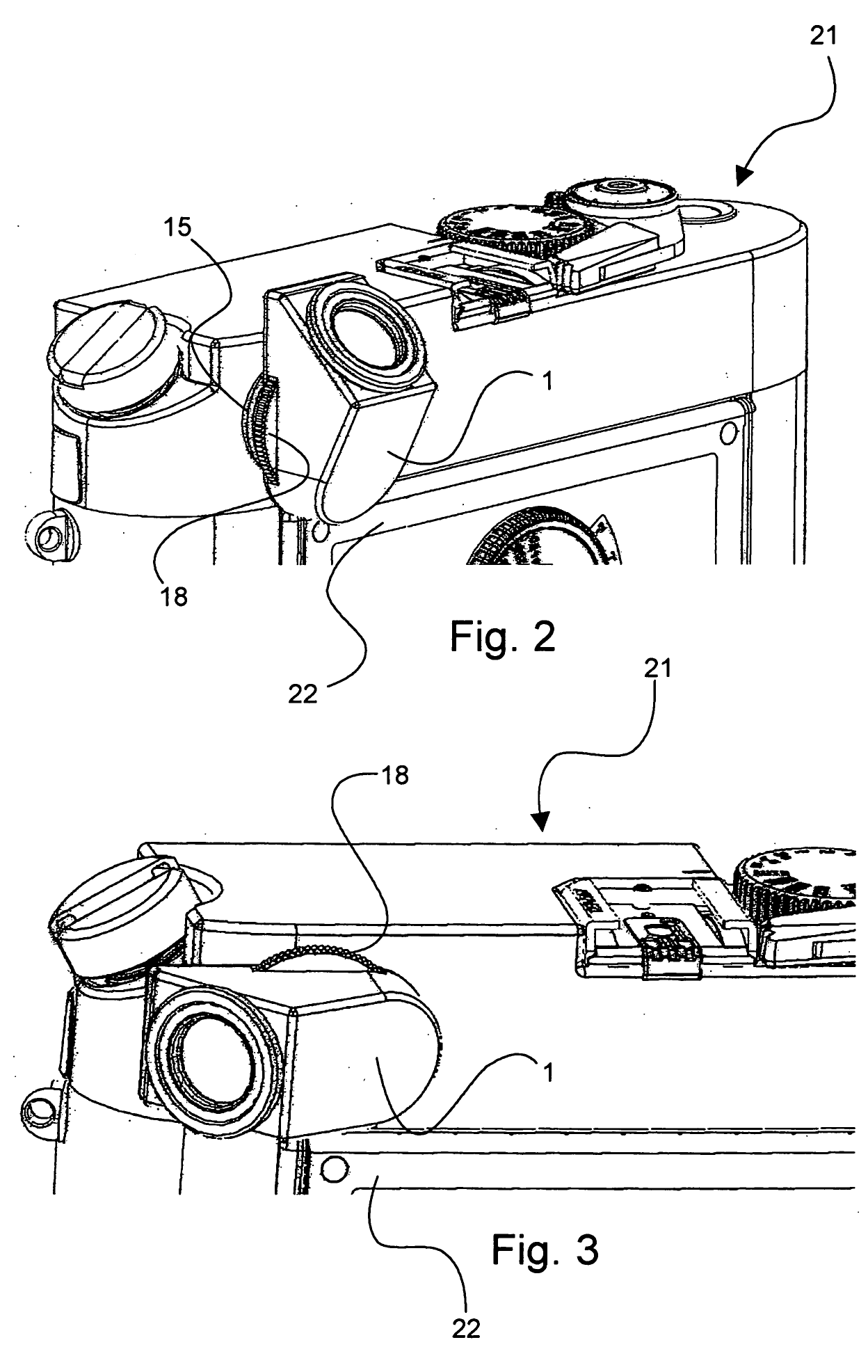

FIG. 2 shows the housing 1 screwed on to the eyepiece finder 15 of a rangefinder camera 21 in a vertical position. The knurled ring 18 projecting laterally from the housing 1 can clearly be seen in this case.

FIG. 3 likewise shows an illustration of the housing 1 screwed onto the eyepiece of a rangefinder camera 21, but in a horizontal position. The compact design can be seen particularly clearly here; it allows insertion of new film via rear film pressure plate 22 despite the screwed-on housing 1.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined with reference to the claims appended hereto.

### LIST OF REFERENCE SYMBOLS

1 Housing of the angular attachment
2 Incident ray
3 Plane glass sheet
4 Base area
5 Bauernfeind prism
6 Adhesive film
7 Air clearance
8 Reflective area
9 Totally reflected ray
10 Light exit area
11 Eyepiece mount
12 Eyepiece plane glass sheet
13 Rubber reinforcement
14 Internal thread
15 Eyepiece finder
16 Fixing screw
17 External thread
18 Knurled ring
19 Sliding knob
20 Entrance diameter
21 Camera
22 Film pressure plate

What is claimed is:

1. An angular attachment for fixing to an eyepiece of a rangefinder camera with laterally correct and height-correct representation of a finder image at an altered eyepiece angle, comprising:
a housing for fixing to the eyepiece of the rangefinder camera;
an image deflection element comprising a Bauernfeind prism with double reflection in one plane; and
a plane glass sheet arranged with an air clearance before a base area of the Bauernfeind prism; wherein
a first region of the base area of the Bauernfeind prism is disposed downstream of an eyepiece finder, an area opposite to this first region is formed as a reflective area and is inclined with respect to the base area in such a way that a ray entering the first region perpendicularly is reflected onto a second region of the base area at an angle of total reflection, the first region and the second region having a common overlap region, and
a light exit area of the Bauernfeind prism is inclined relative to the base area in such a way that the totally reflected ray impinges perpendicularly on the light exit area.

2. An angular attachment according to claim 1, wherein the reflective area forms an angle of 24° with respect to the base area and the light exit area forms an angle of 48° with respect to the base area.

3. An angular attachment according to claim 1, wherein a frame-type adhesive film is provided as a spacer.

4. An angular attachment according to claim 1, wherein the housing has an eyepiece mount on a light exit side, said eyepiece mount being closed off with a plane glass sheet toward the interior of the housing and being provided with a rubber member on the eyepiece side.

5. An angular attachment according to claim 4, wherein the eyepiece mount has on the eyepiece side an internal thread for receiving a dioptre compensation lens.

6. An angular attachment according to claim 1, wherein on a light entry side, a fixing screw is mounted rotatably in the housing and has an external thread for screwing into an eyepiece finder of the camera.

7. An angular attachment according to claim 6, wherein the fixing screw has a knurled ring projecting from the housing.

8. An angular attachment according to claim 5, wherein on a light entry side, a fixing screw is mounted rotatably in the housing and has an external thread for screwing into an eyepiece finder of the camera.

9. An angular attachment according to claim 8, wherein the internal and external threads are of the M12×0.5 type.
